(19) United States
(12) Patent Application Publication
(10) Pub. No.: US 2007/0011251 A1
(43) Pub. Date: Jan. 11, 2007

(54) Fuel cartridge for fuel cell power systems and methods for power generation

(76) Inventors: Kevin W. McNamara, Red Bank, NJ (US); Richard M. Mohring, East Brunswick, NJ (US); Keith A. Fennimore, Columbus, NJ (US); Grant Berry, Hillsborough, NC (US); Paul Sabin, Needham, MA (US); Peter Rezac, Marlborough, MA (US); Jeff Baldic, Milford, MA (US); William Brown, Berlin, MA (US); Paul Osenar, Westford, MA (US)

Correspondence Address: DICKSTEIN SHAPIRO LLP, 1825 EYE STREET NW, Washington, DC, 20006-5403, US

(21) Appl. No.: 11/296,578

(22) Filed: Dec. 8, 2005

Related U.S. Application Data
(60) Provisional application No. 60/634,263, filed on Dec. 9, 2004.

(51) Int. Cl. G06F 15/16

(52) U.S. Cl. 709/206

(57) ABSTRACT

A fuel cell power system including a removable hydrogen generation fuel cartridge module and method are disclosed. The fuel cell power system incorporates one or more of the following elements: a) a mechanism for fuel regulation which may be controlled by an auxiliary module; b) a means for heat exchange in communication with the reactor and/or the fuel cartridge body; c) an air filter for the incoming oxidant gas feed to the power module; d) a means to transfer mechanical energy from the power module to the fuel cartridge; and e) a means for heat exchange.

### RELATED APPLICATION

This application claims the benefit of U.S. Provisional Application Ser. No. 60/634,263, filed Dec. 9, 2004, which is hereby incorporated by reference herein.

### STATEMENT REGARDING FEDERALLY SPONSORED RESEARCH OR DEVELOPMENT

This invention was made with Government support under Technology Investment Agreement FA8650-04-3-2411 awarded by the United States Air Force. The United States Government has certain rights to this invention.

### FIELD OF THE INVENTION

The invention relates to a hydrogen generation fuel cartridge module and an associated, removably connectable fuel cell power module.

### BACKGROUND OF THE INVENTION

Hydrogen is the fuel of choice for fuel cells. However, its widespread use is complicated by the difficulties in storing the gas. Many hydrogen carriers, including hydrocarbons, metal hydrides, and chemical hydrides are being considered as hydrogen storage and supply systems. In each case, specific systems need to be developed in order to release the hydrogen from its carrier, either by chemical reaction or physical desorption.

One advantage of fuel cell power systems over batteries is that fuel cell power systems are readily refuelable and, therefore, can comprise a “replaceable” fuel cartridge module, and a “permanent” power module. A hydrogen fuel cell for small applications needs to be compact and lightweight, have a high gravimetric hydrogen storage density, and preferably be operable in any orientation. Additionally, it should be easy to match the control of the system's hydrogen flow rate and pressure to the operating demands of the fuel cell.

### BRIEF SUMMARY OF THE INVENTION

The present invention provides power generation methods and systems that produce power from fuel cell power systems.

One embodiment of the present invention provides a fuel cell power system comprising a removable hydrogen generation fuel cartridge module incorporating one or more of the following elements:

a) a mechanism for fuel regulation, which may be controlled by a separate hydrogen generation auxiliary module;

b) a means for heat exchange in communication with the reactor and/or the fuel cartridge body; and

c) an air filter for oxidant gas feed to the power module.

Each of the foregoing elements may be used singularly or in any combination, as desired.

According to another embodiment of the present invention, a means to transfer energy from the power module, for example, via a hydrogen generation auxiliary module to the fuel cartridge is provided to control fuel regulation. This minimizes the need for elaborate valving or pumps in the fuel cartridge module that could result in a high unit cost or complexity.

In another aspect of the invention, a means for heat exchange may be incorporated into the fuel cell power system. Preferably, the means for heat exchange is a heat exchanger incorporated into the permanent power module to minimize the need for liquid-liquid coolant connections between the fuel cartridge and the power module and to minimize the weight of the fuel cartridge.

Another embodiment of the present invention provides a method for generating power from a fuel cell power system by employing a removable hydrogen generation fuel cartridge module. The method comprises the steps of (i) providing a removable hydrogen generation fuel cartridge module that comprises an element selected from the group consisting of a mechanism for fuel regulation which may be controlled by an auxiliary module, a means for heat exchange in communication with the reactor and/or the fuel cartridge body, and an air filter for the incoming oxidant gas feed to the power module; and (ii) regulating the fuel flow in the removable fuel cartridge by controlling the transfer of energy from the power module to the removable fuel cartridge.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

FIGS. 1A, 1B, 1C and 1D are illustrations of a power system comprising a fuel cartridge module and a power module in accordance with one embodiment of the present invention;

FIGS. 2A and 2B are schematic illustrations of an exemplary valve control for fuel regulation in accordance with the present invention;

FIG. 3 is a schematic illustration of an exemplary peristaltic pump control for fuel regulation in accordance with the present invention;

FIGS. 4A and 4B are schematic illustrations of an exemplary diaphragm pump control for fuel regulation in accordance with the present invention;

FIG. 5 is an illustration of a power system comprising a fuel cartridge module and a power module in accordance with another embodiment of the present invention;

FIG. 6 is a schematic illustration of an exemplary throttle valve for fuel regulation in accordance with the present invention;

FIGS. 7A and 7B are illustrations of a power system comprising a fuel cartridge module with air filter and a power module;

FIGS. 8A and 8B are illustrations of a power system comprising a fuel cartridge module with an air filter and a power module with a heat exchanger element in a hydrogen auxiliary module;

FIGS. 9A and 9B are illustrations of a power system comprising a fuel cartridge module with an air filter and a power module with a heat exchanger element in a fuel cell module;

FIGS. 10A and 10B are illustrations of a hydrogen generation reactor with a heat sink in accordance with one embodiment of the present invention;

FIG. 11 is an illustration of a hydrogen generation reactor with a heat sink in accordance with another embodiment of the present invention;

FIG. 12 is an illustrative view of a fuel cartridge in accordance with the present invention showing hydrogen and air outlets, heat exchanger connection, and fuel regulator connections; and

FIG. 13 is a schematic illustration of a fuel cartridge in accordance with the present invention including a hydrogen gas generation system with an internal moving plate containing a catalyst chamber.

### DETAILED DESCRIPTION OF THE INVENTION

The present invention provides a fuel cell power system comprising a removable hydrogen generation fuel cartridge module incorporating one or more of the following elements: a) a mechanism for fuel regulation which may be controlled by a hydrogen generation auxiliary module; b) a means for heat exchange in communication with the hydrogen generator reactor and/or the fuel cartridge body; and c) an air filter for the incoming oxidant gas feed to a power module. The present invention also provides a method of generating power from a fuel cell power system by employing a removable hydrogen generation fuel cartridge module.

One advantage of fuel cell power systems over batteries is that the former are readily refuelable and, therefore, can contain a “replaceable” fuel cartridge module, and a “permanent” power module. The fuel cartridge module may be disposable or it may simply be refillable, and may include fuel storage and hydrogen generation components. The power module may include the fuel cell module, specifically the fuel cell stack and related balance of plant components, and a hydrogen generation auxiliary module with fuel regulation and other controls (the combination of such elements can be referred to as the hydrogen generation system's balance of plant). The elements in the power module may be intended to last the lifetime of the power production device.

Hydrogen generation fuels suitable for the fuel cartridge of the present invention include reformable fuels. As used herein, reformable fuels are generally any fuel material that can be converted to hydrogen via a chemical reaction in a reactor, and include, for example, hydrocarbons and chemical hydrides. Useful hydrocarbon fuels include, for example, methanol, ethanol, propane, butane, gasoline, and diesel. Hydrocarbons undergo reaction with water to generate hydrogen gas and carbon oxides. Methanol is preferred for such systems in accordance with the present invention.

Useful chemical hydride fuels include, for example, the alkali and alkaline earth metal hydrides having the general formula MHₙ wherein M is a cation selected from the group consisting of alkali metal cations such as sodium, potassium or lithium and alkaline earth metal cations such as calcium, and n is equal to the charge of the cation; and boron hydride compounds. The chemical hydrides react with water to produce hydrogen gas and a metal salt.

Useful boron hydrides include, for example, boranes, polyhedral boranes, and anions of borohydrides or polyhedral boranes, such as those disclosed in co-pending U.S. patent application Ser. No. 10/741,199, entitled “Fuel Blends for Hydrogen Generators,” the content of which is hereby incorporated herein by reference in its entirety. Suitable boron hydrides include, without intended limitation, the group of borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, where M is a cation selected from the group consisting of alkali metal cations, alkaline earth metal cations, aluminum cation, zinc cation, and ammonium cation, and n is equal to the charge of the cation; and neutral borane compounds, such as decaborane (14) (B₁₀H₁₄), ammonia borane compounds of formula NHₓBH_{y}, wherein x and y independently=1 to 4 and do not have to be the same, and NHₓRBH_{y}, wherein x and y independently=1 to 4 and do not have to be the same, and R is a methyl or ethyl group. M is preferably sodium, potassium, lithium, or calcium. Examples of suitable metal hydrides, without intended limitation, include NaH, LiH, MgH₂, NaBH₄, LiBH₄, NH₄BH₄, and the like. These metal hydrides may be utilized in mixtures, but are preferably utilized individually.

Many of the boron hydride compounds are water soluble and stable in aqueous solution. Sodium borohydride is generally preferred due to its gravimetric hydrogen storage density of 10.9%, its multi-million pound commercial availability, its relative stability in alkaline aqueous solutions, and its comparatively high solubility in water, about 35% by weight as compared to about 19% by weight for potassium borohydride. A stabilizer is typically added to aqueous solutions of borohydride compounds in water to be used as the fuel from which the hydrogen gas is generated. The stabilizer component is preferably a metal hydroxide having the general formula M(OH)ₙ, wherein M is a cation selected from the group consisting of alkali metal cations, such as sodium, potassium or lithium, alkaline earth metal cations, such as calcium, aluminum cation, and ammonium cation, and n is equal to the charge of the cation. Examples of suitable metal hydroxides, without intended limitation, include NaOH, LiOH, NH₄OH and the like. It is preferred that the cation portion of the alkaline stabilizing agent be the same as the cation of the metal hydride salt. For example, if the metal borohydride is sodium borohydride, the preferred alkaline stabilizing agent would be sodium hydroxide, both of which are preferred in the practice of the present invention. Typically, a fuel solution may comprise about 10% to 35% by wt. sodium borohydride and about 0.01 to 5% by weight sodium hydroxide as a stabilizer. A process for generating hydrogen from such a stabilized metal hydride solution is described in U.S. Pat. No. 6,534,033, entitled “A System for Hydrogen Generation,” the content of which is hereby incorporated herein by reference in its entirety.

Chemical hydrides may also be used as a dispersion or emulsion in a nonaqueous solvent, for example, as commercially available mineral oil dispersions. Such dispersions may include additional dispersants as disclosed in U.S. patent application Ser. No. 11/074,360, entitled “Storage, Generation, and Use of Hydrogen,” the content of which is hereby incorporated herein by reference in its entirety.

In embodiments of fuel cartridge modules of the present invention containing a reformable fuel hydrogen generation system, the fuel solutions may be conveyed from a fuel storage area through a reactor chamber in order to undergo the reformation reaction to produce hydrogen. Representative reformation reactions are depicted in Equation 1(a) for a borohydride based hydrogen generation system where MBH₄ and MB(OH)₄, respectively, represent a metal borohydride and a metal borate, and Equation 1(b) for a methanol based hydrogen generation reaction.
MBH₄+4 H₂O→MB(OH)₄+4 H₂ Equation 1(a)
CH₃OH+H₂O→3 H₂+CO₂ Equation 1(b)

For both chemical hydrides and hydrocarbons, the hydrogen and/or any other gaseous products may be separated from the non-hydrogen products in a hydrogen separation region. The hydrogen gas may then be fed to the fuel cell unit. For chemical hydride systems, the non-hydrogen products typically comprise a metal salt product and potentially water vapor. For hydrocarbons, the non-hydrogen products typically comprise carbon oxides (e.g., CO₂, CO) and potentially other contaminant gases. In the case of hydrocarbons, this hydrogen-rich gaseous stream is typically subjected to an additional purification step before being sent to the fuel cell unit.

The hydrogen generation process and liquid fuel flow to the reactor are preferably regulated, by a hydrogen generation auxiliary module, in accordance with the hydrogen demands of the fuel cell. A minimum number of interconnections between the power module and the fuel cartridge module are preferred to reduce system volume, complexity, and cost. Interconnections between the power module and the fuel cartridge module configured to transport gases or liquids are preferably formed from a pliable material such as silicone tubing. When the two components are connected, the tubing is compressed and acts as an o-ring to minimize leakage.

There may optionally be at least one electrical connection between the power module and fuel cartridge module to transmit electricity to provide data signals and/or electrical power, and at least one optional control means, such as a microcontroller or microprocessor within the fuel cartridge. The cartridge can further comprise sensors to measure operating parameters including, but not limited to, temperature and pressure, or status information related to the operating history of the cartridge including, but not limited to, hours of operation or fuel remaining. That information can be transmitted to the fuel cartridge control means and power module controllers as needed.

For the case of a disposable fuel cartridge, locating the reaction chamber within the fuel cartridge reduces the need for the hydrogen generation catalyst to be durable against wear in the long term. System complexity also may be reduced because the catalyst bed does not necessarily need to be flushed or otherwise maintained during its lifetime. Alternatively, if the fuel cartridge is refillable, the reaction chamber could itself be replaceable.

The reaction chamber preferably includes a hydrogen generation catalyst to promote the conversion of the reformable fuel to hydrogen, for example, the hydrolysis of chemical hydrides and steam reforming of hydrocarbons. The catalyst bed is preferably packed with a catalyst metal supported on a substrate. The catalyst may take the form of powders, beads, rings, pellets or chips, among others. Structured catalyst supports such as honeycomb monoliths or metal foams can be used to control the flow pattern and mass transfer of the fuel to the catalyst surface.

Suitable supported catalysts for boron hydride systems are provided, for example, in U.S. Pat. No. 6,534,033 entitled “System for Hydrogen Generation,” and co-pending U.S. patent application Ser. No. 11/167,608 entitled “Hydrogen Generation Catalysts and Systems for Hydrogen Generation,” the disclosures of which are incorporated herein by reference. Suitable transition metal catalysts for the generation of hydrogen from a metal hydride solution include metals from Group IB to Group VIIIB of the Periodic Table, either utilized individually or in mixtures, or as compounds of these metals. Representative examples of these metals include, without intended limitation, transition metals represented by the copper group, zinc group, scandium group, titanium group, vanadium group, chromium group, manganese group, iron group, cobalt group and nickel group. Examples of useful catalyst metals include, without intended limitation, ruthenium, iron, cobalt, nickel, copper, manganese, rhodium, rhenium, platinum, palladium, and chromium.

Suitable supported catalysts for hydrocarbon systems include, for example, metals on metal oxides. Specific examples of useful catalyst metals include, without intended limitation, copper, zinc, palladium, platinum, and ruthenium, and specific examples of useful catalyst metal oxides include, without intended limitation, zinc oxide (ZrO), alumina (Al₂O₃), chromium oxide, and zirconia (ZrO₂).

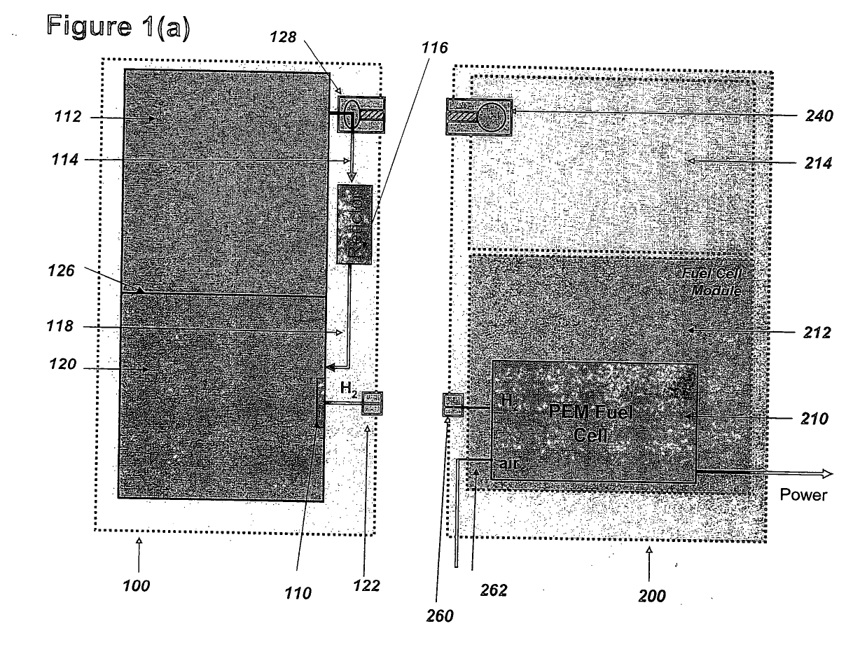

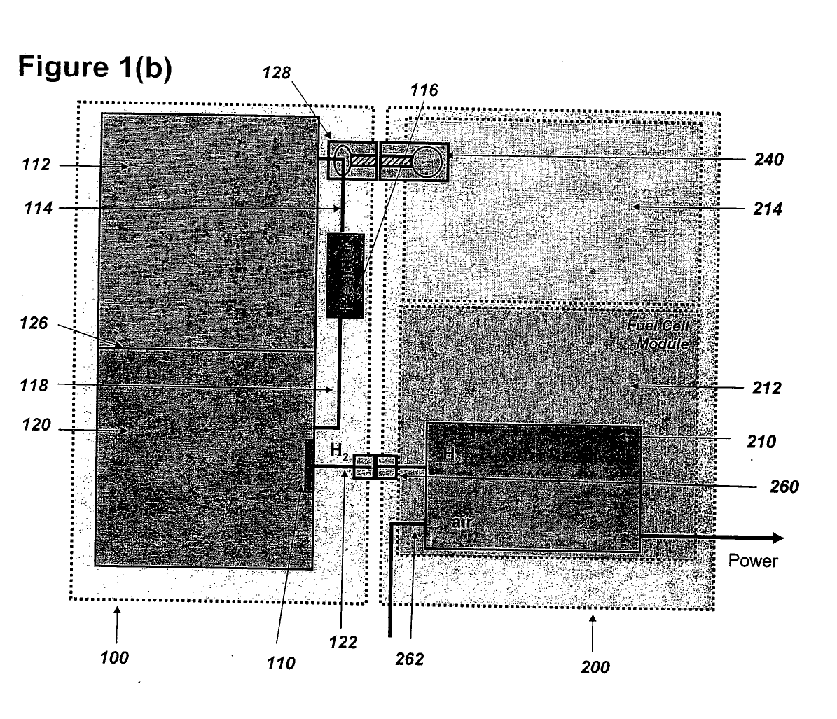

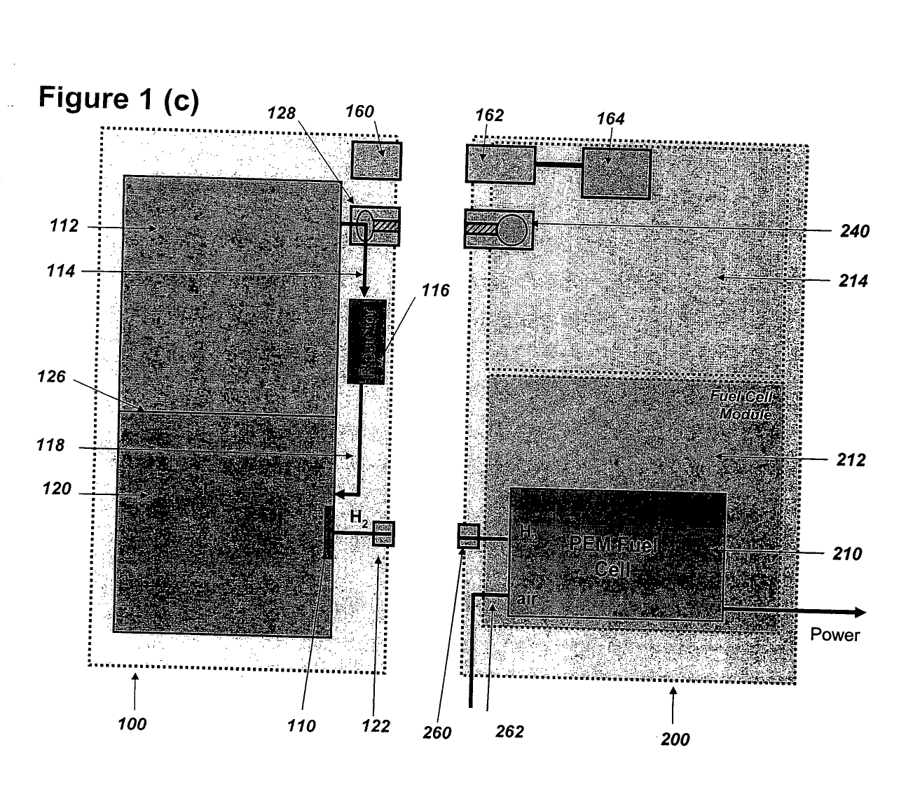

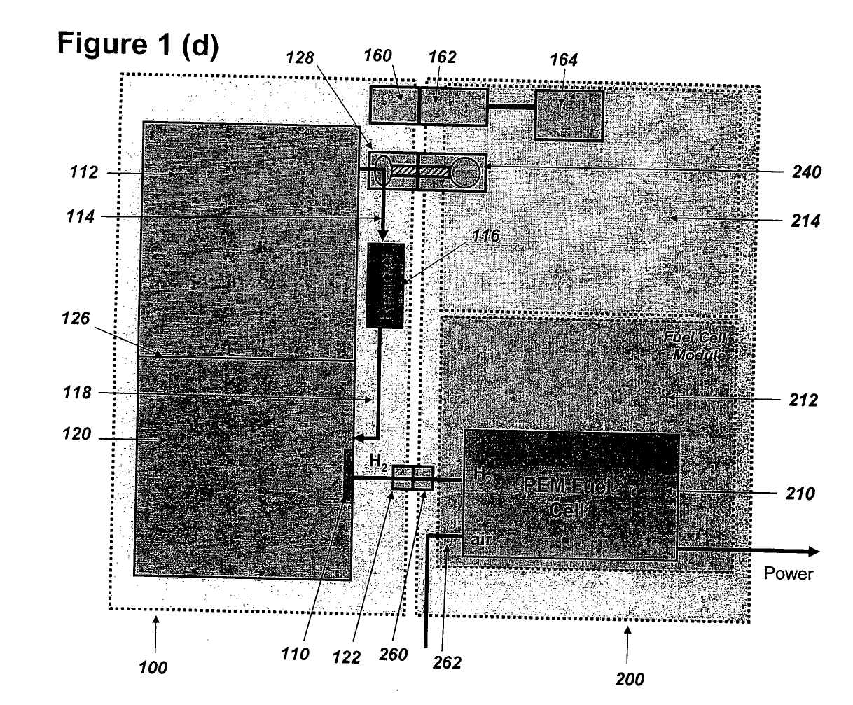

Referring now to FIG. 1, an exemplary power system comprises a fuel cartridge module 100 and a power module 200, which are shown separated in FIG. 1(a) and connected in FIG. 1(b). The fuel cartridge module 100 comprises a fuel storage area 112, and a hydrogen separation area 120 separated by at least one partition 126, fuel regulator mechanism 128, a reactor for hydrogen generation 116, a means for hydrogen separation 110, and a hydrogen outlet 122. The fuel cartridge module 100 may further include one or more water storage areas (not illustrated in FIG. 1). The water storage areas may be separated from fuel storage area 112 and/or hydrogen separation area 120 by at least one partition 126. One or more of partitions 126 may be moveable such that the fuel, water, and byproduct can occupy the same volume in a volume exchanging configuration. In one embodiment of the present invention, the partition may be connected to an optional spring or other such elastic means having intrinsic tension to maintain an applied pressure on the fuel solution within the fuel storage area.

According to one embodiment of the present invention, the fuel storage chamber 112 contains a reformable fuel which is fed through fuel line 114 to reaction chamber 116, which contains a catalyst to enhance the reaction of the fuel solution to produce hydrogen gas as described herein. Water can be added to the reactor from the one or more water storage areas as needed to generate hydrogen from the reformable fuel. Such dilution may preferably be used, for example, when high concentrations of a boron hydride are used in aqueous solution or when nonaqueous compositions such as hydrocarbons or chemical hydride dispersions in nonaqueous solvents are utilized, and water may be added to dilute and react with the reformable fuel as taught in U.S. patent application Ser. No. 10/741,032 entitled “Catalytic Reactor for Hydrogen Generator Systems” and U.S. patent application Ser. No. 10/223,871 entitled “System for Hydrogen Generation,” the disclosures of which are incorporated by reference herein in their entirety.

The reaction results in the generation of hydrogen gas and non-hydrogen products which are transported to the hydrogen separation area 120 via conduit 118. The hydrogen is preferably delivered through hydrogen separation membrane 110 to the power module 200 containing fuel cell 210 via hydrogen inlet 260 for conversion to electrical energy. Examples of suitable membrane materials for hydrogen separation include those materials known to be more permeable to hydrogen than water, such as silicon rubber, fluoropolymers, or any suitable hydrogen-permeable metal membranes such as palladium-gold alloys.

Power module 200 comprises hydrogen inlet 260, an air inlet 262, a hydrogen generation auxiliary module 214, and a fuel cell module 212 that may include a hydrogen-consuming fuel cell 210 comprising a fuel cell stack and associated balance of plant components. A fuel regulator controller 240 may be present in the hydrogen generation auxiliary module 214 as depicted in FIGS. 1, 7, 8, and 9, or may be included within the fuel cartridge module 100; in the latter case, control signals and/or power for controller 240 may be provided from the power module 200. The fuel cartridge module 100 may be connected to the power module 200 by, for example, the hydrogen outlet 122 of the fuel cartridge and the hydrogen inlet 260 of the power module, and between the fuel regulator controller 240 and mechanism 128, as shown in FIG. 1(b). This interface connection is separable and needs only to ensure that the connectors are touching and operable. A latch mechanism may be incorporated in the housing to further attach the power module 200 and fuel cartridge module 100. Examples of latch mechanisms include, but are not limited to, tongue and groove connections, compression latches, buckles, magnetic latches, draw latches, and tension catches. A tongue and groove connection comprises a groove in at least a portion of the housing of the fuel cartridge module 100 (or power module 200) and a corresponding ridge in the power module 200 (or fuel cartridge module 100) such that two modules can mate by sliding the ridge into the groove.

The fuel cartridge and power module of the present invention may optionally include a connector for transfer of electricity to transmit data signals and/or provide electrical power. Referring to FIGS. 1(c) and 1(d) which show the fuel cartridge module 100 and the power module 200 separated and connected, respectively, the fuel cartridge further comprises a cartridge electrical connector 160, and the power module further comprises a power module electrical connector 162 and signal processor 164. Such electrical connectors can transmit data such as operating parameters including, but not limited to, temperature and pressure, and status information related to the operating history of the cartridge including, but not limited to, hours of operation or fuel remaining. The electrical connectors may further provide a means to prevent either unit from activating or operating without being connected. Power may be provided from the fuel cell in the power module to operate devices such as, but not limited to, pumps and fans in the fuel cartridge.

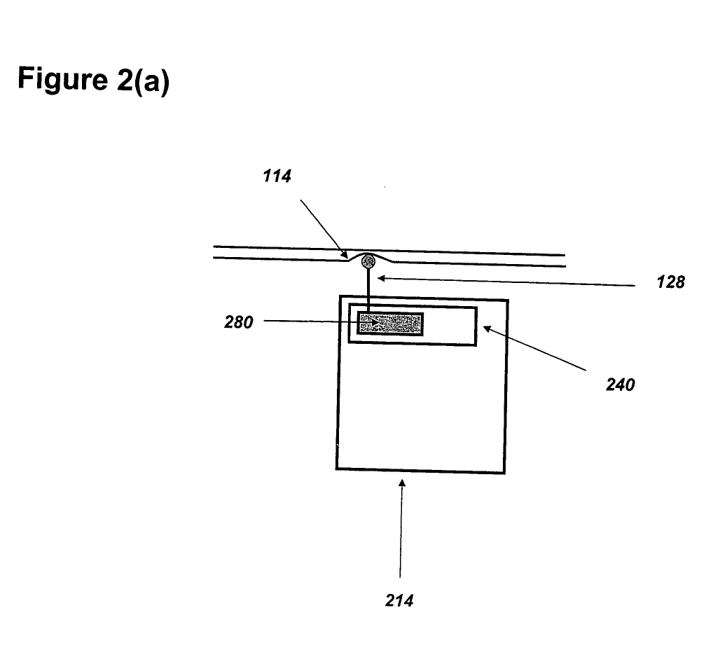

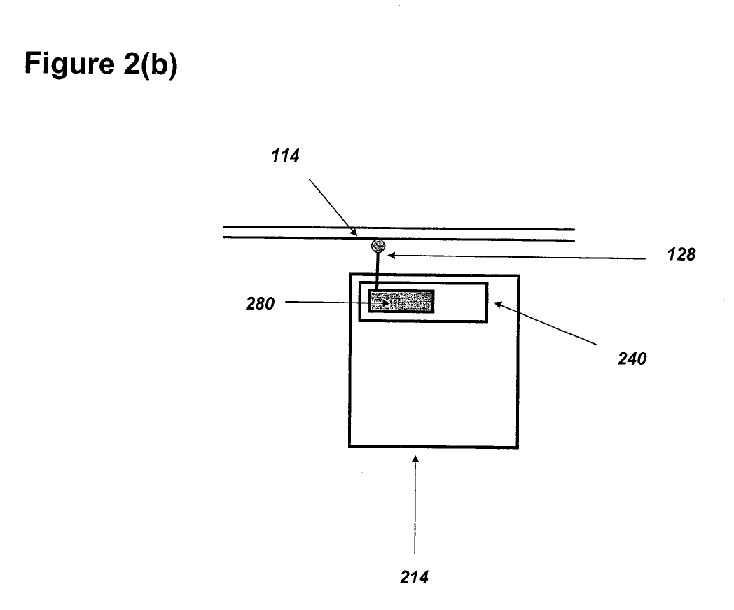

In one embodiment of the present invention, fuel regulator controller 240 and fuel regulator mechanism 128 employ mechanical energy transferred from the hydrogen generator auxiliary module 214 to control liquid fuel flow within the fuel cartridge. As illustrated in FIG. 2, mechanism 128 is a pinch valve. Fuel flow can be regulated through the use of a valve coupling acting as the fuel regulator means 128 in fuel line 114.

The fuel regulator control 240 may be a pinch valve body 280, residing in the hydrogen generator auxiliary module 214 contained within the power module 200 as shown in FIG. 2 or may be included within the fuel cartridge 100. Pinch valve body 280 varies the constriction of fuel line 114 by moving pinch valve 128 in response to control signals from a control unit that may be contained within the hydrogen generator auxiliary module 214 or in the power module. For example, when the electrical power demand from the fuel cell 210 decreases, the control unit will signal the pinch valve body 240 to constrict fuel line 114 via valve 128 as shown in FIG. 2(a), thus reducing the fuel flow to reaction chamber 116, which in turn reduces the rate of hydrogen production. If the electrical demand from fuel cell 210 is zero, the pinch valve body 240 will constrict fuel line 114 completely via valve 128. Likewise, when the electrical power demand increases, the control unit signals the pinch valve body 240 to relieve constriction on fuel line 114 via valve coupling 128 as shown in FIG. 2(b), increasing the fuel flow and the rate of hydrogen production.

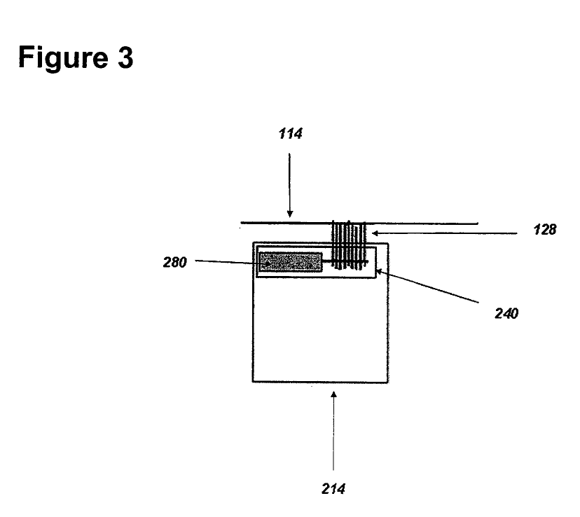

In another embodiment of the present invention, the mechanical energy is transferred from the hydrogen generation auxiliary module 214 to control liquid fuel flow within the fuel cartridge by employing a pump. As shown in FIG. 3, mechanism 128 is a pump head of a peristaltic pump, a piston pump, or other such pump having a pump head that is driven by a motor 280, wherein the pumping mechanism can be external to fuel line 114.

In general, such pumps operate through the use of a pump head 128 comprised of a series of fingers in a linear or circular configuration, a circular arrangement of rollers, or at least one piston which can compress the fuel line. A linear peristaltic pump is illustrated in FIG. 3. As the motor 280 turns, the compression of the fuel line 114 by the fingers 128 forces the liquid through the line. When the line is not compressed and open, fluid flows into the fuel line. The fingers may be in a variety of configurations and alternatively referred to as rollers, shoes, or wipers.

Pump body 280 may reside in the hydrogen generator auxiliary module 214 contained within the power module 200 as shown in FIG. 3 or may be included within the fuel cartridge 100. Pump body 280 varies the flow of fuel through the fuel line 114 by varying its pumping speed in response to control signals from the control unit that may be contained within the hydrogen generator auxiliary module or in the power module. For example, when the electrical power demand from the fuel cell 210 decreases, the control unit will signal the peristaltic pump body 280 to operate its motor at lower speed, thus reducing the fuel flow to reaction chamber 116, which in turn reduces the rate of hydrogen production. If the electrical demand from fuel cell 210 is zero, the peristaltic pump body 280 will not operate its motor and no fuel will be propelled through fuel line 114. Likewise, when the electrical power demand increases, peristaltic pump body 280 is operated at a higher speed, thus increasing fuel flow to reaction chamber 116, and increasing the rate of hydrogen production.

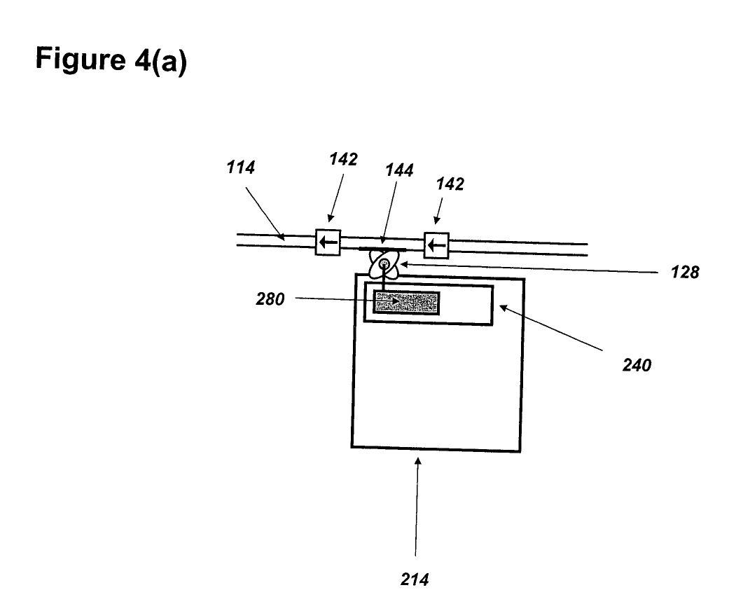

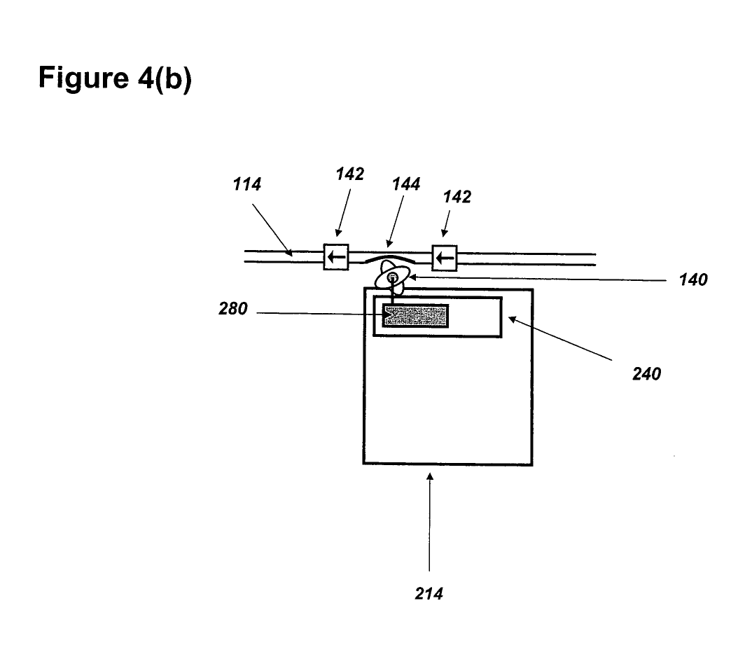

In another embodiment of the present invention, energy is transferred from the hydrogen generation auxiliary module 214 to control liquid fuel flow within the fuel cartridge by employing a diaphragm pump. As shown in FIG. 4, mechanism 128 is a pump head of a diaphragm pump. A diaphragm pump comprises a diaphragm 144 in fuel line 114, check valves 142 on the upstream and downstream sides of the diaphragm, and pump head 128.

In general, such diaphragm pumps operate through the use of a pump head 128 comprised of one or more cams in a linear or circular configuration or at least one piston which can compress diaphragm 144. The pump head is illustratively shown as a cam that rotates and pulses or flexes the diaphragm in FIG. 4(b). As the motor 280 turns, the compression of the membrane 144 by the fingers 128 forces the liquid through the line. When the membrane expands and is not compressed as depicted in FIG. 4(a), fluid is drawn into the fuel line. The cams may be in a variety of configurations and alternatively referred to as rollers, shoes, or wipers. The check valves constrain the flow through diaphragm 144 and fuel line 114 so that liquid flows in the directions indicated by the arrows in check valves 142.

Pump body 280 may reside in the hydrogen generator auxiliary module 214 contained within the power module 200 as shown in FIG. 4 or may be included within the fuel cartridge 100. Pump body 280 varies the flow of fuel through diaphragm 144 and fuel line 114 by varying its pumping speed in response to control signals from the control unit that may be contained within the hydrogen generator auxiliary module or in the power module. For example, when the electrical power demand from the fuel cell 210 decreases, the control unit will signal the pump body 280 to operate its motor at lower speed, thus reducing the fuel flow to reaction chamber 116, which in turn reduces the rate of hydrogen production. If the electrical demand from fuel cell 210 is zero, the pump body 280 will not operate its motor and no fuel will be propelled through diaphragm 144 and fuel line 114. Likewise, when the electrical power demand increases, pump body 280 is operated at a higher speed, thus increasing fuel flow to reaction chamber 116, and increasing the rate of hydrogen production.

In another embodiment of a diaphragm pump configuration, fuel regulator means 128 is omitted and diaphragm 144 further comprises a piezoelectric crystal. Fuel regulator control 240 may comprise an electrical contact such that when the fuel cartridge and power module are mated, the electrical contact 240 is in communication with the piezoelectric crystal in diaphragm 144. Upon the application of an oscillating voltage to the piezoelectric crystal, a diaphragm pumps fluid through the conduit line as described previously for the mechanically controlled diaphragm.

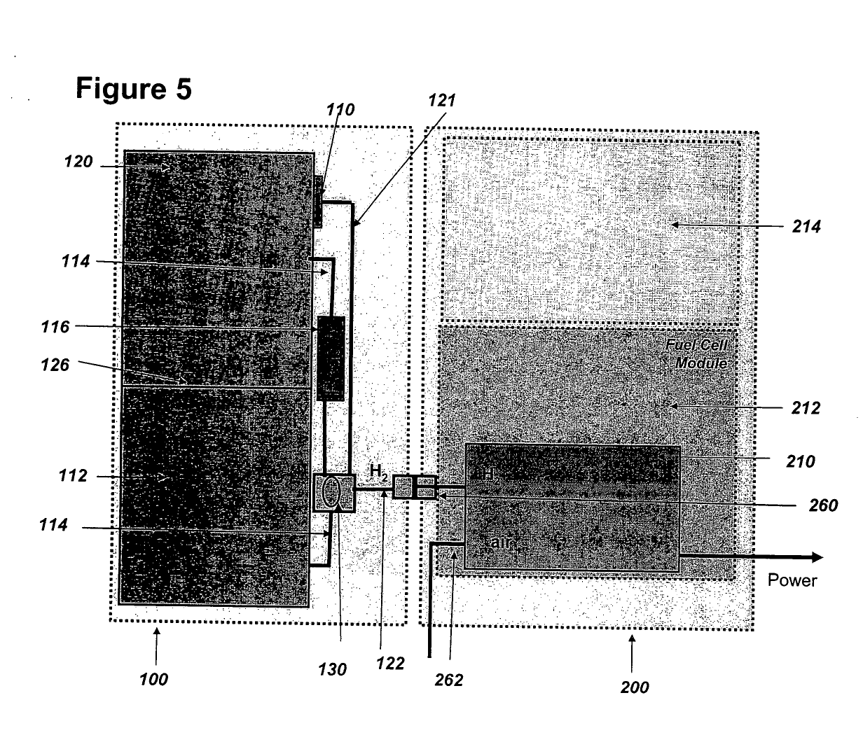

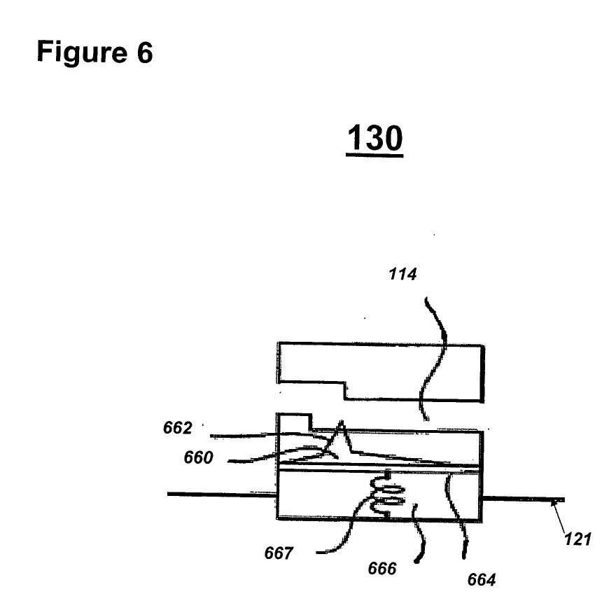

In another embodiment of the present invention, fuel regulator controller 240 and fuel regulator mechanism 128 may be replaced with a passive fuel regulator means 130 as illustrated in FIG. 5 wherein hydrogen gas pressure from the reformable fuel hydrogen generation system is used. Gas pressure from other sources may be utilized as well, for instance, ambient air may be fed to the valve. In that case, the hydrogen conduit 121 would not connect to regulator means 130 but rather directly to hydrogen outlet 122. An example of a passive fuel regulator is a throttle valve as described in U.S. patent application Ser. No. 10/359,104 entitled “Hydrogen Gas Generation System,” the content of which is hereby incorporated herein by reference in its entirety. Referring now to FIG. 6 wherein the passive fuel regulator 130 is a throttle valve, the cross section of fuel line 114 as it passes through valve 130 may be varied by movement of a valve operator 660 having a tapered leading edge 662 to create a variable orifice, and control the flow of fuel to reactor 116.

The movement of the valve operator 660 is controlled by a diaphragm 664 and a pressure chamber 666 such that a change in pressure causes movement of the valve operator 660. A spring 667 can also be employed. The pressure in the pressure chamber 666 is established by the hydrogen that passes outwardly from the hydrogen separation area 120 via hydrogen line 121 to hydrogen outlet 122. As the hydrogen gas passes through the pressure chamber 666, a pressure is established which may be controlled by a check valve or other regulator (not illustrated). The hydrogen generation reaction can therefore be self-regulating so that as hydrogen is produced and not consumed, the pressure within the pressure chamber 666 increases and forces the leading edge 662 of the valve operator 660 to obstruct or narrow fuel line 114 and reduce the flow of fuel to reactor 116. As a result, the amount of hydrogen produced is reduced. As hydrogen is consumed and the pressure in pressure chamber 666 decreases, the valve operater 660 recedes and increases the effective area of fuel line 114 and increasing the flow of the fuel to reactor 116.

To minimize variability in the operation of the fuel cell stack and to account for operation of the power supply under a variety of environmental conditions, it is preferred that the incoming oxidant gas supply, typically air, is filtered. Thus, the incorporation of an air filter for the fuel cell into the fuel cartridge module ensures that this filter can be readily replaced without impacting the “permanent” fuel cell portion of the power supply. Indeed, a fresh filter could be available each time the fuel cartridge is changed.

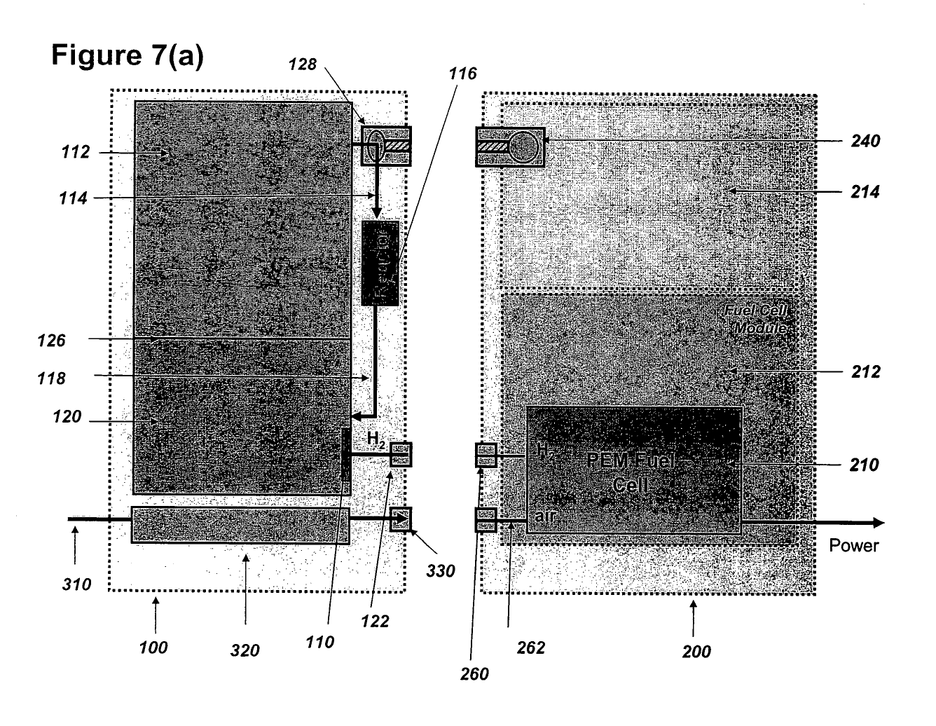

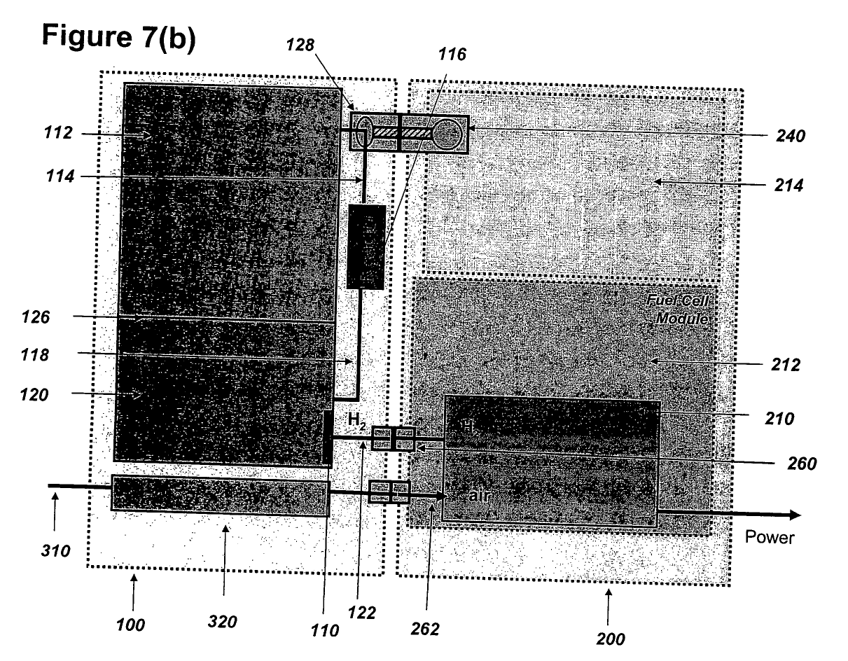

Referring to FIG. 7, wherein features that are the same as those shown in FIG. 1 have like numbering, the fuel cartridge module further comprises an air filter 320, an air inlet 310, and an air outlet 330, in addition to a fuel storage area 112, a hydrogen separation area 120 separated by a partition 126, fuel regulator mechanism 128, a reactor for hydrogen generation 116, a means for hydrogen separation 110, and a hydrogen outlet 122. Hydrogen is produced as described for the system illustrated in FIG. 1, and delivered to power module 200. The fuel cartridge module 100 may be connected to the power module 200 by, for example, the hydrogen outlet 122 and air outlet 330 of the fuel cartridge and the hydrogen inlet 260 and air inlet 262 of the power module, and between the fuel regulator controller 240 and mechanism 128 as shown in FIG. 7(b).

The hydrolysis reaction of chemical hydride compounds is exothermic. For example, the hydrolysis of sodium borohydride shown in Equation 1(a) generates about 300 kJ for each mole of sodium borohydride reacted. As an example, the hydrolysis of sodium borohydride to produce hydrogen equivalent to 60 W produces about 10 to 18 watts of heat. In order to ensure that the liquid fuel in the fuel storage region does not significantly decompose due to thermal hydrolysis prior to passage through the reactor, a means for heat removal from the fuel cartridge and/or reactor is preferred to allow efficient use, particularly at elevated temperatures above about 35° C. Furthermore, the use of a heat exchanging element to minimize heating within the reactor limits the vaporization of water within the reaction chamber, which both improves reaction efficiency and prevents premature metal salt precipitation and potential clogging of the reactor.

Alternatively, at low temperatures, temperature control of the fuel cartridge is important to ensure that the metal salt product of the hydrolysis reaction does not precipitate from solution in the reactor or feed lines leading to the hydrogen separation region and that the reactor itself remains within the optimum range for hydrogen generation. At temperatures below about 10° C., it is preferred that a thermal loop be incorporated into the fuel cartridge for efficient operation. The use of heat exchanger elements to ensure that the incoming fuel feed is at the optimal temperature for hydrogen generation is described in co-pending U.S. patent application Ser. No. 10/867,032 entitled “Catalytic Reactor for Hydrogen Generation Systems,” the disclosure of which is hereby incorporated by reference.

The reforming of hydrocarbon fuels to produce hydrogen is an endothermic process so heat needs to be supplied to the reactor. In such case, heat can be transferred from the fuel cell to the reactor. Additional heating elements may be present in order to ensure that the reactor can reach typical reforming temperatures above about 200° C.

Preferably, the heat exchanger is incorporated into the permanent power module section to minimize the need for liquid-liquid coolant connections between the fuel cartridge and the power module. The benefit of including the more expensive unit components in the power module simplifies the fuel cartridge manufacturing and controls the cost of the fuel cartridge for the user.

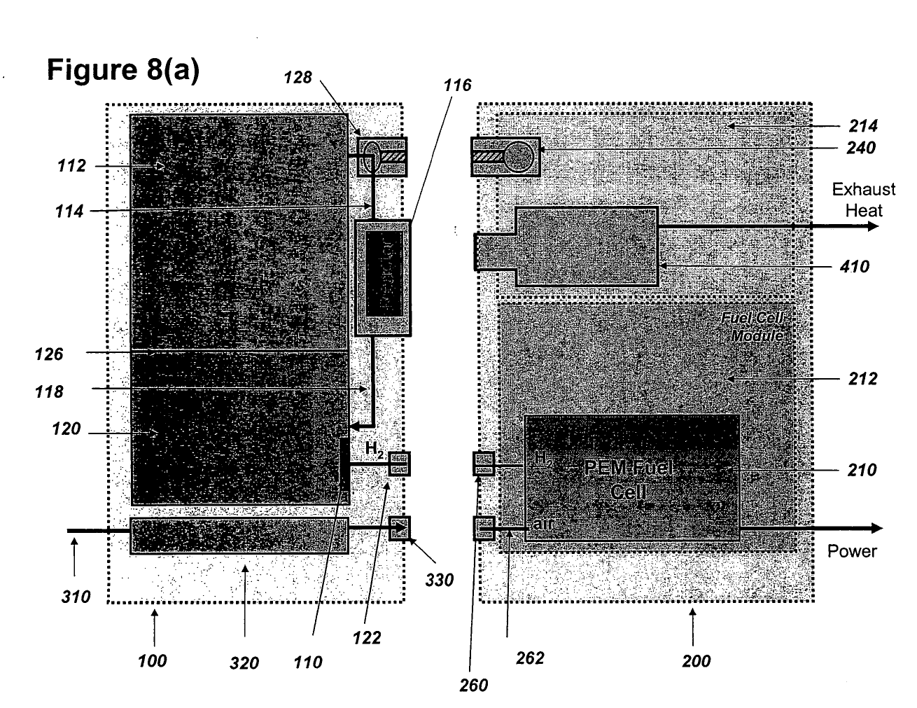

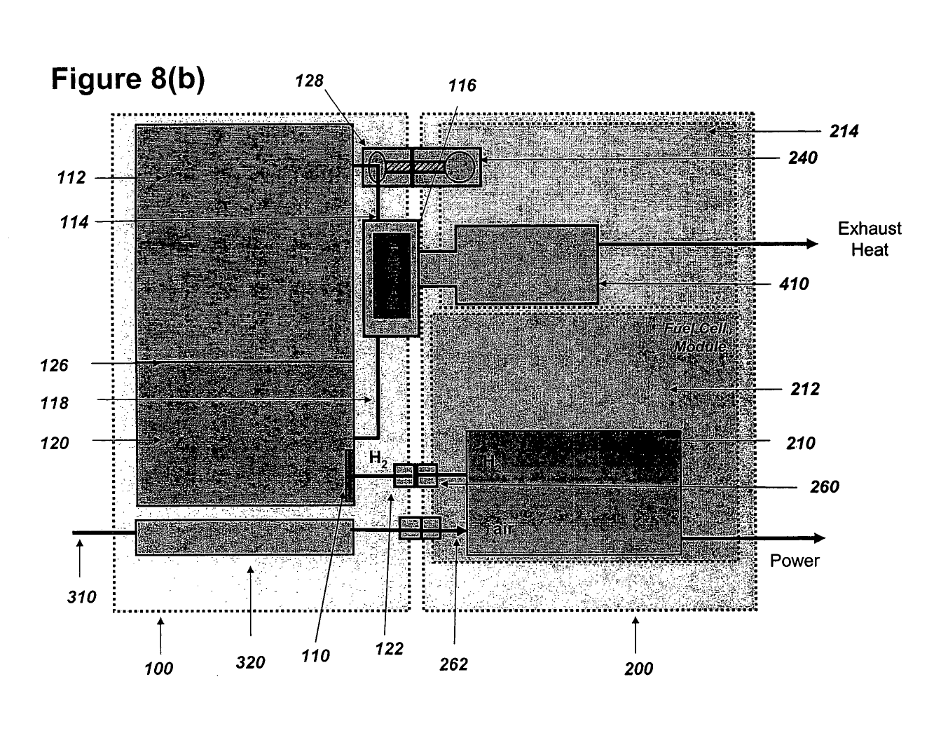

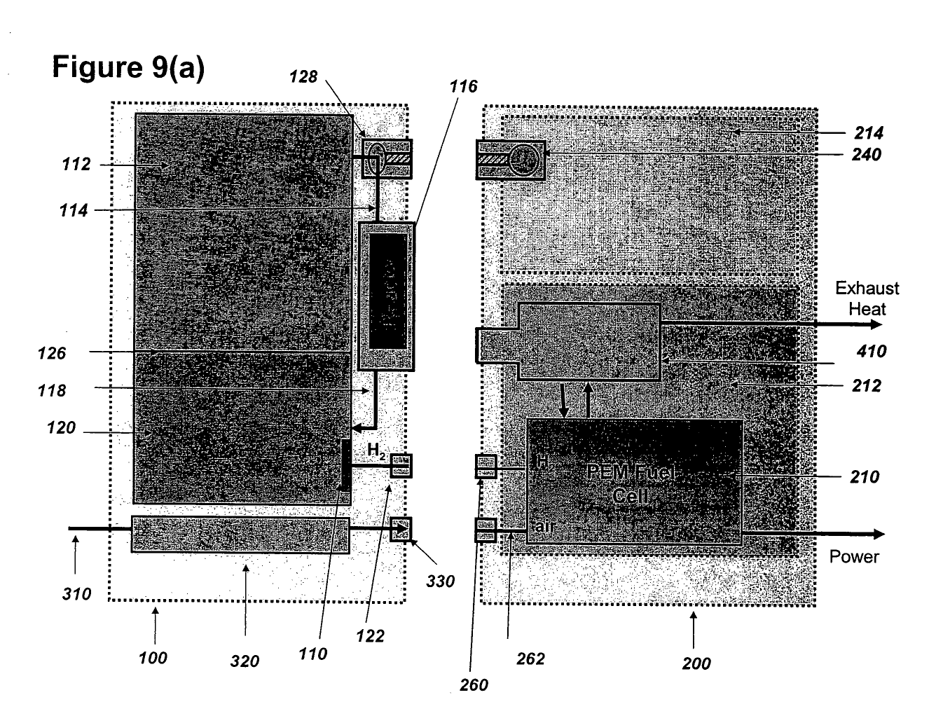

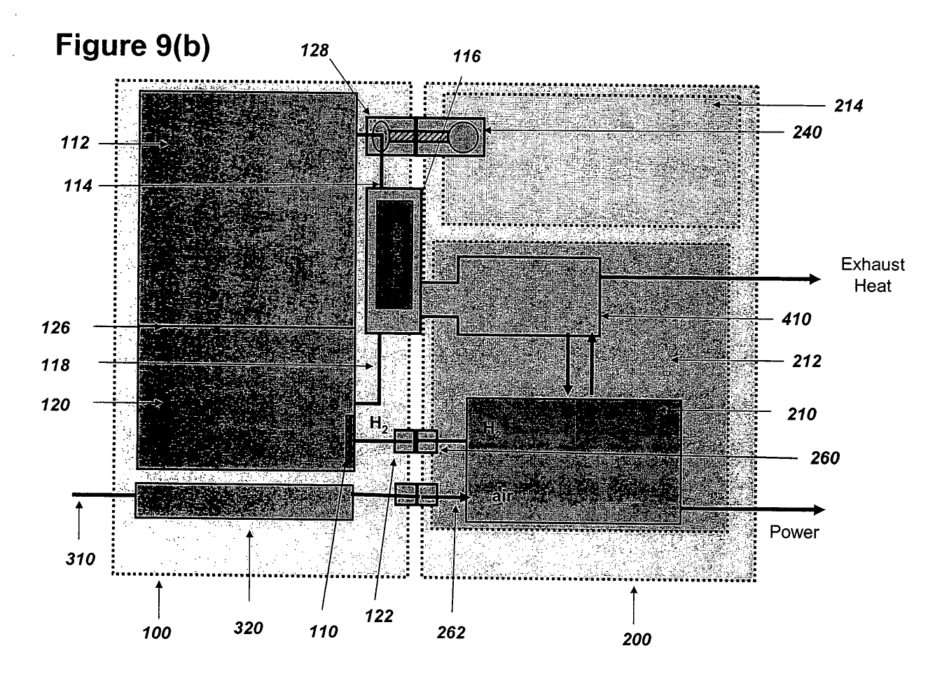

Referring to FIGS. 8 and 9, wherein features that are the same as those shown in FIG. 1 have like numbering, the fuel cartridge further comprises heat exchanger 410, which may be in either the hydrogen generation auxiliary module 214 or within the fuel cell module 212. The heat exchanger 410 may be integrated with or be independent of any heat exchanger used for temperature regulation of the fuel cell and may comprise liquid- or air-cooling loops. The fuel cartridge module 100 may be connected to the power module 200 by, for example, the hydrogen outlet 122 and air outlet 330 of the fuel cartridge and the hydrogen inlet 260 and air inlet 262 of the power module, the reactor 116 and heat exchanger 410, and between the fuel regulator controller 240 and mechanism 128 as shown in FIGS. 8(b) and 9(b).

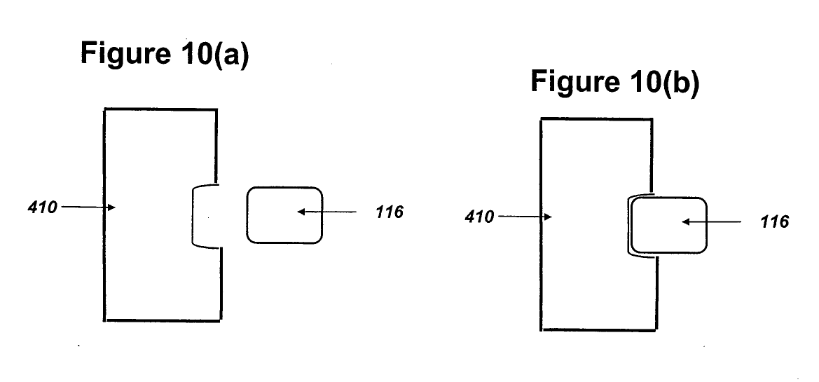

The connection between the reactor 116 and the heat exchanger 410 may be a simple interface wherein a face of the reactor abuts a face of the heat exchanger. Alternatively, the face of heat exchanger 410 on the power module may be grooved such that the reactor 116 can snap into or slide into the groove as illustrated in FIG. 10. A thermally conductive material may be used to facilitate contact and heat transfer between the two faces. Preferably, such material is compressible to ensure contact without requiring the fuel cartridge and power module be manufactured to exceedingly high tolerances. Nonlimiting examples of useful thermally conductive material include ceramic filled silicone elastomers and metal felts.

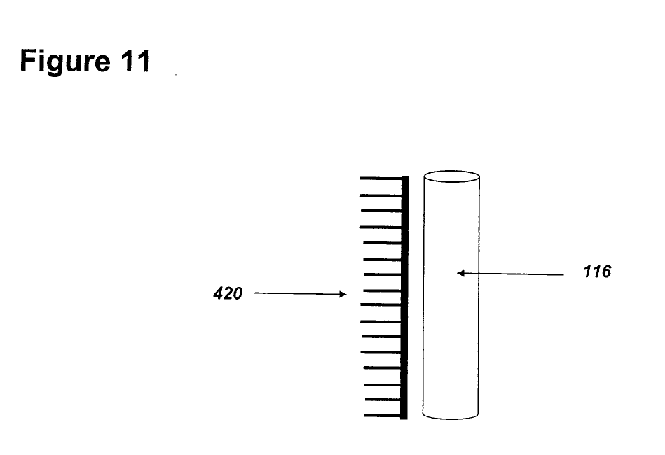

For systems in which heat removal from the reactor is more important than heating of the reactor, passive heat exchanging elements may be alternatively or additionally included with the fuel cartridge module. An illustration of a reactor 116 connected to a heat sink 420 with fins for radiative cooling is shown in FIG. 11. Heat may be passively radiated from a heat sink or an optional fan may blow across the fins. A fan may also cool the fuel cartridge body as a whole.

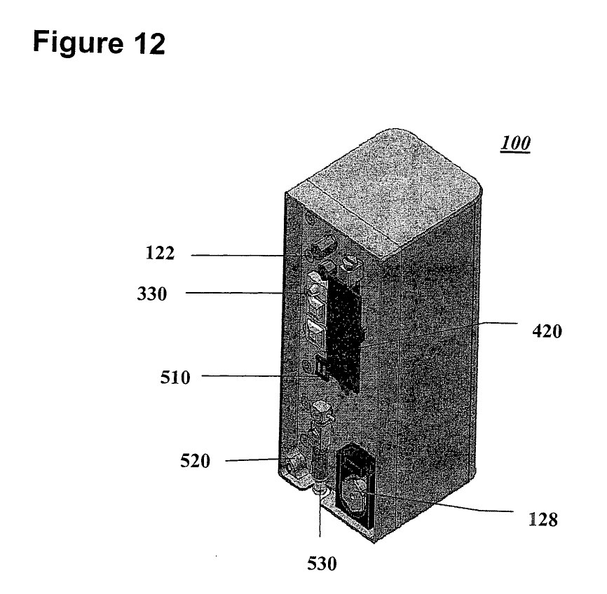

An illustrative arrangement of external connections for a fuel cartridge according to the present invention showing hydrogen outlet 122, air outlet 330, reactor heat sink 420, fuel regulator 128, pressure relief valve 520, and electrical interface 510 is shown in FIG. 12. An optional fill port 530 is depicted to facilitate re-fueling the cartridge. An optional drain port (not illustrated) may be included to facilitate removal of any solid or liquid products produced from the reaction of the reformable fuels in the generation of hydrogen. Such connections would not need to be present for disposable fuel cartridges.

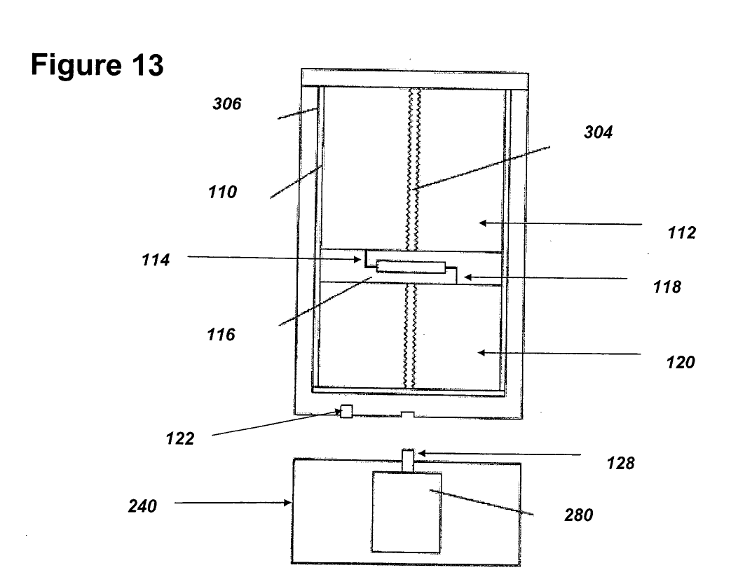

Another embodiment of the present invention that utilizes energy transfer from the hydrogen generation auxiliary module to control liquid fuel flow within the fuel cartridge is illustrated in FIG. 13 wherein the system employs a reactor 116 contained in a plate 302 which separates the hydrogen separation region 120 and the fuel region 112 of the fuel cartridge. A motor body 280 in the hydrogen generator auxiliary module 240 located in the power module turns a screw mechanism 304 via connector 128 to move plate 302 and propels fuel through fuel line 114 and thus through the reactor 116 contained in the plate 302. The cross section of the cartridge can be any shape, but prismatic shapes are preferred. At least a portion of the walls of the hydrogen separation region 120 and the fuel region 112 comprise a hydrogen membrane 110 to transfer hydrogen to a hydrogen storage region 306 from where it can be delivered to a fuel cell via hydrogen outlet 122. Examples of suitable membranes for hydrogen separation include those materials known to be more permeable to hydrogen than water, such as silicon rubber, microporous fluoropolymers, or any suitable hydrogen-permeable metal membranes such as palladium-gold alloys.

While the present invention has been described with respect to particular preferred embodiments, it should be understood that numerous other embodiments are within the scope of the present invention. For instance, while illustrative fuel cartridges have been described including both air filter and heat exchanging elements in combination with a means to transfer energy from the hydrogen auxiliary module, no separate auxiliary module need be present and, for example, a heat exchanger could be used without incorporating an air filter into the cartridge.

1. A fuel cartridge configured for removable connection to a fuel cell power module, comprising:
a reformable fuel hydrogen generation system containing a fuel storage region, a hydrogen gas separation region, and a reactor;
a fuel regulator configured to regulate fuel flow from the fuel storage region to the reactor;
a hydrogen outlet in communication with the hydrogen separation region; and
at least one separable interface selected from the group consisting of:
a mechanism to connect the fuel regulator to the power module;
a heat exchanger for transfer of heat between the fuel cartridge and the power module;
an electrical connector for transmitting electricity between the fuel cartridge and the power module; and
an air outlet configured to provide filtered air to the power module.

2. The fuel cartridge of claim 1, wherein the fuel regulator comprises a diaphragm pump head.

3. The fuel cartridge of claim 1, wherein the fuel regulator comprises a piezoelectric pump.

4. The fuel cartridge of claim 1, wherein the fuel regulator comprises a peristaltic pump head.

5. The fuel cartridge of claim 1, wherein the fuel regulator comprises a screw driven plate.

6. The fuel cartridge of claim 1, wherein the reformable fuel hydrogen generation system further comprises a fuel inlet.

7. The fuel cartridge of claim 1, wherein the fuel storage region is separated from the hydrogen separation region by at least one movable partition.

8. The fuel cartridge of claim 1, wherein the fuel storage region contains at least one boron hydride fuel component.

9. The fuel cartridge of claim 1, wherein the reformable fuel hydrogen generation system further comprises at least one water storage region.

10. The fuel cartridge of claim 1, wherein the reactor comprises a hydrogen generation catalyst.

11. The fuel cartridge of claim 10, wherein the hydrogen generation catalyst is in a form selected from the group consisting of pellets, chips, monoliths, and powders.

12. The fuel cartridge of claim 1, wherein the fuel cartridge comprises an air filter.

13. The fuel cartridge of claim 1, wherein the fuel cartridge comprises a electrical connector for transmitting data to an optional processor in a power module.

14. The fuel cartridge of claim 1, wherein the fuel cartridge comprises a electrical connector for receiving electrical power from a power module.

15. The fuel cartridge of claim 1, wherein the fuel storage area is refillable.

16. The fuel cartridge of claim 1, wherein the cartridge is disposable.

17. The fuel cartridge of claim 1, wherein the cartridge comprises a signal means adapted for electrical communication with the power module.

18. The fuel cartridge of claim 13, wherein the electrical connector of the fuel cartridge is adapted for removable connection to a electrical connector on the power module.

19. The fuel cartridge of claim 18, wherein the hydrogen generation system is not activatable unless the electrical connectors are connected.

20. The fuel cartridge of claim 1, wherein the fuel storage region and the hydrogen separation region are separated by a movable partition containing a reactor.

21. The fuel cartridge of claim 20, wherein the movable partition is configured to regulate fuel flow to the reactor from a control mechanism in the power module.

22. The fuel cartridge of claim 1, wherein the cartridge comprises a hydrogen permeable membrane in fluid communication with at least one of the hydrogen separation region and the fuel storage region.

23. The fuel cartridge of claim 1, wherein the fuel regulator regulates the flow of fuel to the reactor in response to hydrogen pressure.

24. A fuel cartridge for providing hydrogen to a fuel cell power module, comprising:
a reformable fuel hydrogen generation system containing a heat exchanger for transfer of heat between the system and a removably connectable power module;
a means for fuel regulation containing a mechanism for control by a removably connectable power module; and
a hydrogen outlet configured to provide hydrogen gas to a removably connectable power module.

25. The fuel cartridge of claim 24, wherein the fuel regulation means is selected from the group consisting of a diaphragm pump, a piezoelectric pump, or a peristaltic pump.

26. The fuel cartridge of claim 24, wherein the fuel regulation means comprises a screw driven plate.

27. The fuel cartridge of claim 24, wherein the reformable fuel hydrogen generation system comprises a fuel storage region, a reaction chamber, and a hydrogen separation region.

28. The fuel cartridge of claim 27, wherein the chamber comprises a hydrogen generation catalyst.

29. The fuel cartridge of claim 24, further comprising an air filter, an air inlet, and an air outlet configured to provide filtered air to a power module.

30. The fuel cartridge of claim 24, further comprising a cartridge electrical connector configured to interface with a power module.

31. The fuel cartridge of claim 24, wherein the heat exchanger comprises a heat sink.

32. The fuel cartridge of claim 24, wherein the fuel cartridge further comprises a fan configured to cool the hydrogen generation system.

33. The fuel cartridge of claim 24, further comprising a hydrogen purification system adapted to remove impurities from a gas stream containing hydrogen gas.

34. The fuel cartridge of claim 24, wherein the hydrogen generation system contains a catalyst metal.

35. The fuel cartridge of claim 34, wherein the catalyst metal is supported on a substrate.

36. The fuel cartridge of claim 27, further comprising a water storage area.

37. The fuel cartridge of claim 27, wherein the regions are separated by at least one movable partition configured to provide volume exchange between the regions.

38. The fuel cartridge of claim 24, further comprising a hydrogen separation membrane between the hydrogen separation region and the hydrogen outlet.

39. The fuel cartridge of claim 24, further comprising a heating loop configured to heat the hydrogen generation system.

40. The fuel cartridge of claim 24, further comprising at least one sensing means in electrical communications with a signal processor.

41. The fuel cartridge of claim 24, wherein the fuel storage region contains a reformable hydrocarbon fuel.

42. The fuel cartridge of claim 24, wherein the fuel storage region contains a chemical hydride fuel.

43. A power source comprising:
a power module having a fuel cell, a hydrogen inlet, and an air inlet;
a fuel cartridge having a fuel storage region, a reactor, and a hydrogen outlet;
a fuel control mechanism comprising a fuel regulator in the fuel cartridge; and
wherein the power module and fuel cartridge are separable and share at least one interface for transfer of energy or material selected from the group consisting of data, heat, air, electricity, and mechanical energy.

44. The power source of claim 43, further comprising a means for heat exchange between the reactor and the power module.

45. The power source of claim 44, wherein the means for heat exchange comprises a plate on the power module and an exposed face of the reactor.

46. The power source of claim 43, wherein the power module comprises a hydrogen generation auxiliary module and a fuel cell module and wherein the auxiliary module houses a fuel controller configured to communicate with the fuel regulator.

47. The power source of claim 45, wherein the plate on the power module has at least one groove and the exposed face of the reactor is configured for removable connection with the groove.

48. The power source of claim 45, wherein a thermally conductive material is provided on at least one of the faces or plate.

49. The power source of claim 43, wherein the fuel control mechanism is selected from the group consisting of a diaphragm pump, a piezoelectric pump, a peristaltic pump, and a screw driven plate.

50. The power source of claim 43, wherein the fuel control mechanism is a passive regulator operable by hydrogen pressure in the fuel cartridge.

51. The power source of claim 50, wherein the fuel control mechanism is a throttle valve.

52. The power source of claim 43, wherein the fuel control mechanism comprises at least one sensor and a microprocessor.

53. The power source of claim 43, wherein the fuel control mechanism comprises a movable screw driven plate containing the reactor.

54. The power source of claim 53, wherein the plate is movable in response to a motor assembly in the power module.

55. The power source of claim 54, wherein the plate comprises at least a portion of a movable partition between the fuel storage region and a hydrogen separation region.

56. The power source of claim 43, wherein the fuel cartridge comprises an air filter.

57. The power source of claim 56, wherein the air filter is in fluid communication with an air outlet adapted for removable connection to the air inlet of the power module.

58. The power source of claim 57, further comprising a mechanical interface adapted for control of the fuel regulator.

59. The power source of claim 57, further comprising removably connectable heat exchange and data transmission interfaces between the cartridge and module.

60. A method for generating power from a fuel cell power system, comprising:
providing a fuel cartridge containing a reformable fuel hydrogen generation system, a fuel regulator, and a hydrogen outlet;
providing a power module containing a fuel cell, a hydrogen inlet, and an air inlet;
connecting the fuel cartridge to the power module at at least one removably connectable interface selected from the group consisting of an air conduit, a heat exchanger, and a fuel control mechanism; and
controlling liquid fuel flow in the fuel cartridge to generate hydrogen gas, and transferring the gas to the fuel cell of the power module to generate power.

61. The method of claim 60, wherein the fuel regulator mechanism is selected from the group consisting of a diaphragm pump, a piezoelectric pump, a peristaltic pump, and a screw driven plate.

62. The method of claim 60, further comprising controlling the temperature of the fuel cartridge from a heat exchanger within the power module.

63. The method of claim 60, further comprising controlling the temperature of the fuel cartridge from a heat exchange mechanism within the fuel cartridge.

64. The method of claim 60, further comprising filtering air within the fuel cartridge to provide filtered air to the power module.

65. The method of claim 60, comprising regulating fuel flow in response to hydrogen pressure in the cartridge.

66. The method of claim 60, comprising connecting the cartridge to the module at interfaces between the hydrogen inlet and outlet, an air inlet on the module and an air outlet on the cartridge, and a mechanism for transfer of heat between the cartridge and module.

67. The method of claim 60, further comprising connecting the cartridge, and module at electrical connectors for electronic data transfer.

68. The method of claim 60, wherein the fuel regulator is removably connectable to a fuel controller in the power module.

69. The method of claim 60, wherein the reactor contains a supported catalyst.

70. The method of claim 60, wherein the fuel hydrogen generation system comprises a fuel storage area separated from a hydrogen separator area by a movable partition.

71. The method of claim 60, wherein the fuel hydrogen generation system comprises a refillable fuel storage area.

72. The method of claim 60, wherein the fuel cartridge is disposable.

73. The method of claim 70, wherein the fuel storage area contains a chemical hydride.

74. The method of claim 70, wherein the fuel storage area contains a reformable hydrocarbon.

75. A power source comprising:
a power module having a fuel cell, a hydrogen inlet, and an air inlet;
a fuel cartridge having a fuel storage region, a reactor containing a catalyst, a fuel regulator and a hydrogen outlet;
a mechanism for control of the fuel regulator from the power module;
a means for exchange of heat between the fuel cartridge and the power module;
an interface for transmitting electricity between the fuel cartridge and the power module; and
wherein the power module and fuel cartridge are removably connectable.

76. The power source of claim 75, further comprising an air filter in the fuel cartridge configured to provide filtered air to the power module.

77. The power source of claim 75, further comprising a means for transfer of heat from the reactor to the power module.

78. The power source of claim 75, further comprising a means to transfer heat from the fuel cell to the reactor.
